(19) United States
(12) Patent Application Publication
(10) Pub. No.: US 2004/0239506 A1
(43) Pub. Date: Dec. 2, 2004

(54) Security device which is compatible with various electronic article surveillance systems and a method for securing articles

(76) Inventor: Francois Cosnard, Sevres (FR)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/880,925

(22) Filed: Jun. 30, 2004

Related U.S. Application Data
(63) Continuation of application No. 10/177,389, filed on Jun. 20, 2002.

(30) Foreign Application Priority Data
Dec. 24, 1999 (DE) 199 63 130.1

(51) Int. Cl. G08B 13/14

(52) U.S. Cl. 340/572.9

(57) ABSTRACT

The invention relates to security devices for an electronic product monitoring system which are compatible with various product monitoring systems. The invention also relates to a method of securing products which permits the use of various security devices.

### CROSS-REFERENCE TO RELATED APPLICATIONS

This application is a continuation of International Patent Application No. PCT/EP00/12680, filed Dec. 13, 2000, and the disclosure of which is incorporated herein by reference.

### BACKGROUND OF THE INVENTION

This invention relates to a security device for an electronic article surveillance system, with a housing comprising elements for emitting a characteristic signal and with a fastening element releasably connectible with the housing, with the article to be secured being arranged between, or enclosed by, the housing and the fastening element, and to methods of securing articles in accordance with the subclaims 8 and 9.

Electronic surveillance systems for monitoring articles have been in use in department stores or similar establishments for a long time. These systems essentially are comprised of three components. First, there are security devices which are connected with the article needing to be secured so they cannot be removed by a potential shoplifter. Second, the exit area of the department stores is equipped with detecting devices which detect the presence of a security device in the exit area of the department store, producing in this event an alarm. Third, there are devices for detaching the security device from the items to be secured. As a rule, these are provided at the department store's checkout facilities. After the merchandise has been rightly purchased, the security device is detached from the article to be secured, and the customer may leave the department store unhindered.

The detecting devices typically emit alternating magnetic fields which excite the security devices into emitting a characteristic signal. This characteristic signal is then received by the detecting devices and releases the alarm.

Security devices for the securing of textiles are frequently of the type referred to as “hard tags”. These hard tags are comprised of a housing and a fastening element. The fastening element in turn is comprised of a head and a shank which may be introduced into a corresponding opening in the housing where it snaps into a locking mechanism. The article to be secured is between the head of the fastening element and the housing.

Furthermore, the housing accommodates elements for emitting a characteristic signal, which elements, when entering a corresponding alternating magnetic field of the detecting devices, deliver a characteristic signal, hence enabling a stolen article to be detected.

The locking mechanism is opened by sales staff using a special device after the article to be secured has been paid for. Upon opening of the locking mechanism the housing and the article to be secured are separated, thus enabling the customer to freely pass the detecting devices with the rightly purchased secured article. These hard tags are comparatively expensive considering the housing, the releasable locking mechanism and the electrical components received in the housing. The operator of the department store leases them as a rule; damaged hard tags are replaced on a continuous basis. The annual replacement rate is typically 10 to 20%. Because such leases typically have a 5-year term, the department store operator, in concluding such a lease for the hard tags, is bound to the electronic article surveillance system for this 5-year period for reasons of economy. Furthermore, the manufacturers of electronic article surveillance systems have to wait for a lease to expire before they can convince a department store operator who has been using a competitor's electronic article surveillance system of the advantages of their own electronic article surveillance system and sell it to the department store operator.

### BRIEF SUMMARY OF THE INVENTION

It is therefore an object of the present invention to provide a security device for an electronic article surveillance system and a method for securing articles, which are compatible with nearly any electronic article surveillance system and enable the continued use of existing security devices also upon an exchange of the electronic article surveillance system.

According to the present invention, this object is accomplished by a security device for an electronic article surveillance system, with a housing comprising elements for emitting a characteristic signal and with a fastening device releasably connectible with the locking mechanism, wherein the article to be secured is arranged between, or enclosed by, the housing and the fastening device, and wherein the elements for emitting a characteristic signal are releasably attached to the housing.

In the security device of the present invention the elements for emitting a characteristic signal may be detached from the housing, hence enabling them to be replaced by other elements. This interchangeability of the elements for emitting a characteristic signal makes it possible to achieve compatibility with nearly any electronic article surveillance system. In his decision for or against an electronic article surveillance system, the department store operator is hence independent of the duration of the lease for security devices, in particular hard tags. In the medium and long term, this results in cost savings for the security elements. Furthermore, the elements for emitting a characteristic signal may be developed further continuously and used in existing electronic article surveillance systems.

In one variant of the invention the fastening device includes a fastening element, and the elements for emitting a characteristic signal are arranged between the housing and the fastening element.

According to another variant, the fastening device includes a fastening loop, and the elements for emitting a characteristic signal are secured to a closed loop of the fastening loop.

A feature shared by both variants is that the fastening of the security device to the article to be secured takes place concurrently and without added effort with the fastening of the elements for emitting a characteristic signal to the housing.

In other embodiments of the invention the elements for emitting a characteristic signal are an EM security tag, an AM security tag, an RF security tag or an RFID security tag. An EM security tag is an electromagnetic security tag, an AM security tag is an acoustomagnetic security tag, an RF security tag is a radio frequency security tag, and an RFID security tag is a radio frequency identification security tag. With the exception of the RFID security tag, these security tags are prior art devices used successfully for the securing of a wide variety of items, so that in this context a detailed explanation can be dispensed with.

An RFID security tag typically comprises a receiver coil receiving the electromagnetic signals of the detecting device and providing the inductance of the resonant circuit. The resonant circuit also requires a capacitance which, given two isolated windings, is provided by the receiver coil and/or a capacitor and the ID chip. The ID chip contains several bits of information required for identification of the marked item. When the RFID security tag traverses an electromagnetic field oscillating in the resonant frequency of the resonant circuit, a voltage is induced in the receiver coil which supplies the ID chip. The ID chip then generates signals which are often emitted via the receiver coil so that a wide variety of information can be transmitted to the detecting device, for example.

In contrast to the commercially available security tags, the elements for emitting a characteristic signal advantageously include a bore through which the pin of the fastening element may be passed, so that the fastening of the security tag to the housing is a very simple operation incurring no additional cost. To better protect the security tags against unauthorized removal, the security tag may be reinforced by means of a plastic plate, for example. When the security tag is larger than the fastening element, the sales personnel will be able to see at a glance whether or not a security tag is affixed to the article to be secured.

Supplementary to the invention, the elements for emitting a characteristic signal include a bore and/or reinforcements, thus enabling them to be connected to the housing of the security device in most simple manner by being threaded onto the shank of the fastening element. Furthermore, the safeguard against unauthorized removal of the elements for emitting a characteristic signal is enhanced.

In an embodiment of the invention the security device is a hard tag known in the art with a housing, with elements for emitting a characteristic signal which are fixedly anchored in the housing, and with at least one fastening device releasably connectible with the housing, so that when another electronic article surveillance system is to be substituted the existing hard tags may continue to be used and only an element for emitting a characteristic signal which cooperates with the new electronic article surveillance system is attached to the housing. This embodiment of the invention improves the possibility of a system change.

The object initially referred to is also accomplished by the use of a hard tag known in the art as security device according to any one of the preceding claims, with elements for emitting a characteristic signal being arranged between the housing and the fastening element. The advantages of this use of a hard tag known in the art correspond to the above-mentioned advantages.

Still further, the object initially referred to is accomplished by a method of securing articles, which includes the steps of

placing the article needing to be secured between the housing and the fastening element;

inserting elements for emitting a characteristic signal between the housing and the fastening element; and

connecting the housing and the fastening element, with the article needing to be secured and the elements for emitting a characteristic signal being arranged between, or enclosed by, the housing and the fastening element, so that while existing hard tags continue to be used the electronic article surveillance system may be exchanged or elements for emitting a characteristic signal may be employed, which are an improvement over the hard tags.

Finally, the object initially referred to is also accomplished by a method of securing articles, including the steps of

threading the article needing to be secured onto the fastening loop;

threading the elements for emitting a characteristic signal onto the fastening loop;

connecting the housing and the fastening loop, with the article needing to be secured and/or the elements for emitting a characteristic signal being enclosed by the fastening loop, so that while existing hard tags continue to be used the electronic article surveillance system may be exchanged or elements for emitting a characteristic signal may be employed, which are an improvement over the hard tags.

In an embodiment of the method of the invention the elements for emitting a characteristic signal are an EM security tag, an AM security tag, an RF security tag or an RFID security tag, so that various commercially available security tags may be employed and, in addition, the method is usable on any electronic article surveillance system.

Further advantages and advantageous embodiments of the present invention will become apparent from the subsequent description, the accompanying drawings and the patent claims.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is lis a view of a first embodiment of a security device of the invention and an article to be secured;

FIG. 2 is a longitudinal sectional view of a security device of FIG. 1 and an article to be secured;

FIG. 3 is a view of three embodiments of fastening loops;

FIG. 4 is a view of a first example showing the cooperative relationship between security device, fastening loop and article to be secured;

FIG. 5 is a view of a second example showing the cooperative relationship between security device, fastening loop and article to be secured; and

FIG. 6 is a view of a third example showing the cooperative relationship between security device, fastening loop and article to be secured.

### DETAILED DESCRIPTION OF THE INVENTION

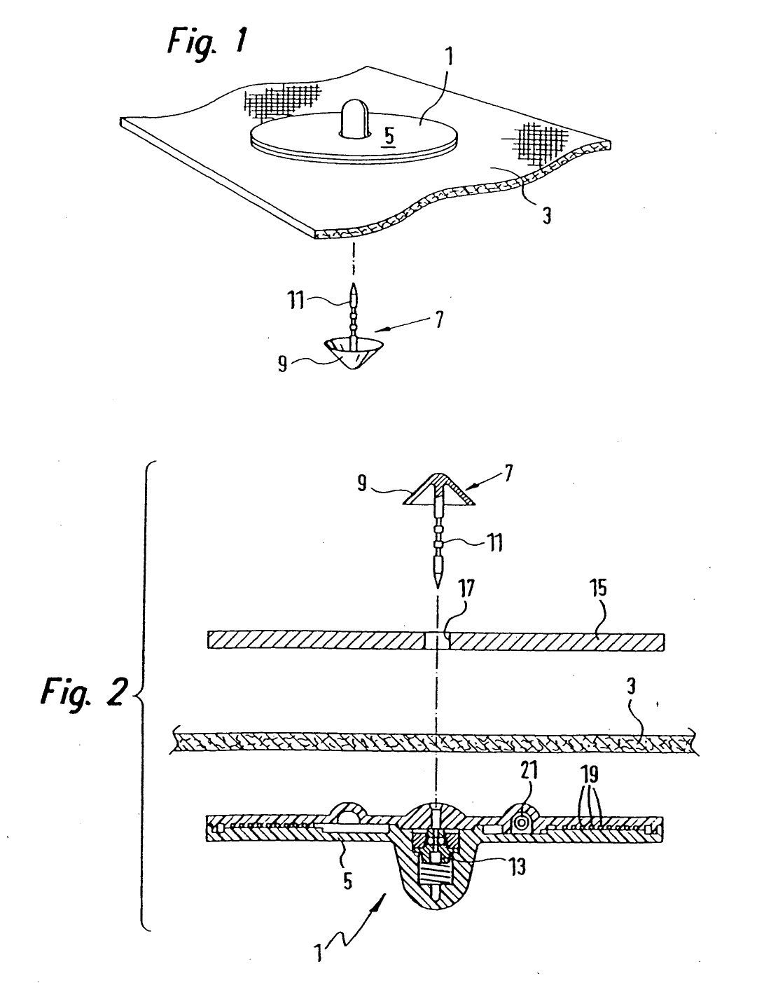

FIG. 1 shows a security device 1 of the invention and an article 3 requiring securing. The security device I is comprised of a housing 5 receiving in its interior a releasable locking mechanism not recognizable in FIG. 1. The fastening element 7 forming part of the security device 1 is comprised of a head 9 and a shank 11. With its shank 11 the fastening element 7 is pressed through the article 3 to be secured, which in this embodiment is a textile, snapping with its shank 11 into the locking mechanism in the housing 5. The head 9 of the fastening element 7 prevents the textile 3 from being removed from the security device 1 without being ruined.

FIG. 2 shows a security device 1 of the invention with an article to be secured prior to assembly. Arranged in the housing 5 of the security device of the invention is a releasable locking mechanism 13 engageable with a snap action by the shank 11 of the fastening element 7.

The housing 5 is attached to the textile 3 to be secured by inserting the shank 11 through the elements 15 for emitting a characteristic signal and through the textile 3 into the locking mechanism 13. For this purpose the elements 15 for emitting a characteristic signal have a bore 17. Once the fastening element 9 is introduced into the locking mechanism 13 along the dot-and-dash line, both the textile 3 and the elements 15 for emitting a characteristic signal are connected with the housing 5 in a manner non-detachable by a shoplifter. It is only by means of a special tool available at the checkout of department stores that the security device is removable from the textile 3 to be secured.

In the embodiment shown the security device 1 is comprised of a conventional hard tag with a resonant circuit fixedly mounted in the housing 5, said circuit including a coil 19 and a capacitor 21, and the elements 15 for emitting a characteristic signal. Because the elements 15 for emitting a characteristic signal may be, for example, an EM, an AM, an RF or an RFID security tag, a detailed showing of the associated electronic components in FIG. 1 or 2 has been dispensed with. Hence only a plate is illustrated which has the necessary mechanical strength and accommodates the electronic components necessary for the emission of a characteristic signal. The reinforcements may also be a housing or the like.

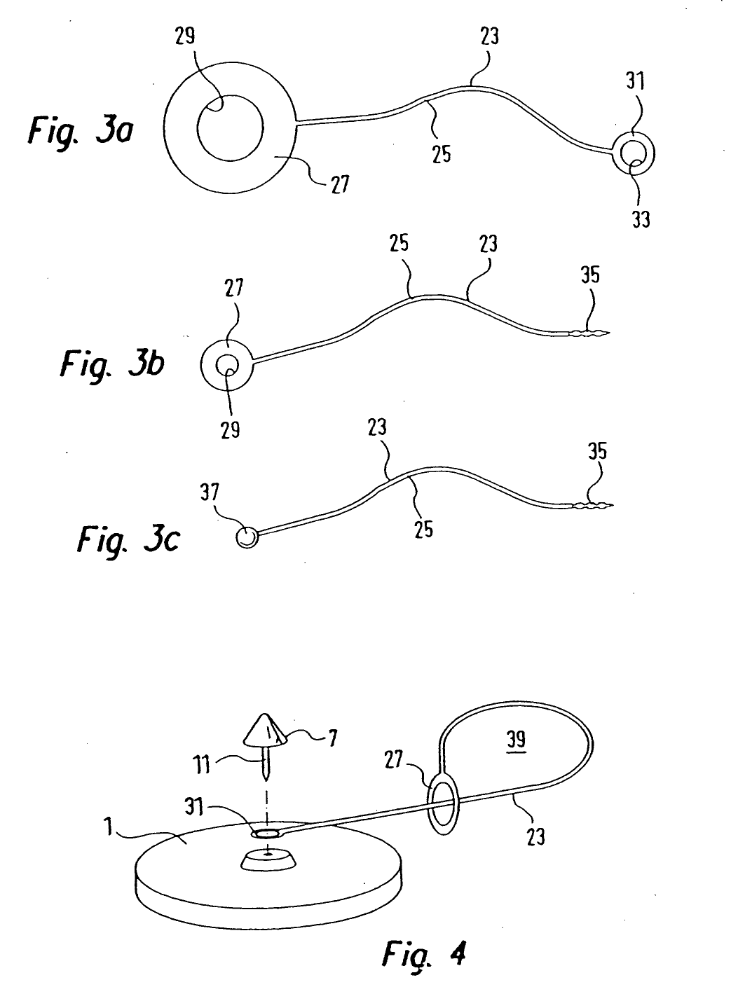

FIGS. 3a, 3b and 3c show fastening loops 23 comprising a wire 25 or the like. With these loops security devices 1 are attachable to items to be secured which contain eyelets, holes or similar elements.

FIG. 3a shows a fastening loop 23 having a first ring 27 or the like of a large inside diameter 29 and a second ring 31 of an inside diameter 33. The second ring 31 may be passed through the first ring 27. The inside diameter 33 is smaller than the diameter of the head 9 of the fastening element 7 in FIGS. 1, 2 and 4.

FIG. 3b shows another fastening loop 23 with a wire 25 whose one end 35 is constructed in the same manner as the shank 11 of a fastening element 7. The other end of the wire 25 is provided with a first ring 27. The inside diameter 29 of the first ring 27 is selected so that the opposite end 35 of the fastening loop 23 may be passed through the first ring 27.

FIG. 3c shows a third example of a fastening loop 23. This fastening loop has a ball 37 at its one end. The other end 35 is configured similar to the shank 11 of a fastening element 7.

FIG. 4 shows the use of a fastening loop 23 according to FIG. 3a for attaching an article not shown, for example, a pair of scissors, to a security device 1. The second ring 31 is passed through the first ring 27, resulting in a closed loop 39. The second ring 31 as well as the elements 15, not shown in FIG. 4, for emitting a characteristic signal are threaded onto the fastening element which is then introduced into the locking mechanism 13 of the security tag where it is fixedly secured in place.

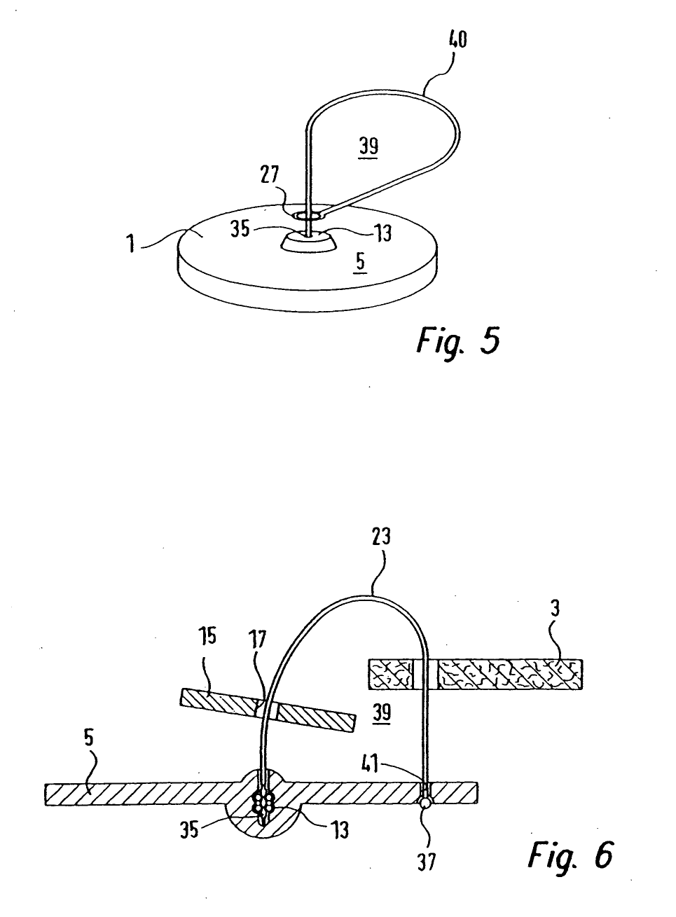

FIG. 5 shows the use of a fastening loop 23 according to FIG. 3b with a security device 1. The loop 39 is formed by passing the end 35 through the first ring 27. The end 35 is then directly inserted into the locking mechanism 13 in the housing 5.

FIG. 6 shows a section through a security device 1, a fastening loop 23 according to FIG. 3b, an article 3 to be secured, and elements 15 for emitting a characteristic signal. The security device 1 includes a bore 41 through which the fastening loop 23 is passed. The ball 37 is greater than the diameter of the bore 41. The end 35 is passed through the article 3 to be secured and through the elements 15 for emitting a characteristic signal, and is subsequently locked in the locking mechanism 13.

By means of the embodiments of security devices 1 and fastening loops 23 described with reference to FIGS. 1 to 6 a wide variety of articles 3 requiring securing may be secured simply and effectively.

It is noted that all the features represented in the description, the subsequent patent claims and the drawings may be essential to the invention, whether taken alone or in any combination.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-10. (Canceled)

11. A security device for an electronic article surveillance system, with a housing comprising a first element of a first technology type for emitting a first characteristic signal and a second element of a second technology type for emitting a second characteristic signal.

12. The security device as claimed in claim 11, wherein said first technology type is resonant circuit technology.

13. The security device as claimed in claim 12, wherein said second technology type is EM security tag technology.

14. The security device as claimed in claim 12, wherein said second technology type is AM security tag technology.

15. The security device as claimed in claim 12, wherein said second technology type is RF security tag technology.

16. The security device as claimed in claim 12, wherein said second technology type is RFID security tag technology.

17. The security tag as claimed in claim 11, wherein said first element for emitting a first characteristic signal is fixed to said housing.

18. The security tag as claimed in claim 17, wherein said second element for emitting a second characteristic signal is completely releasably attached to said housing.

19. The security device as claimed in claim 18, characterized in that said second element for emitting a characteristic signal includes a bore.

20. The security tag as claimed in claim 19, wherein a fastening loop is threaded entirely through said bore.
